(19) United States
(12) Patent Application Publication
(10) Pub. No.: US 2026/0023824 A1
(43) Pub. Date: Jan. 22, 2026

(54) SYSTEM AND METHODS FOR NFT TOKENIZATION OF ASSETS ON AN INTERACTIVE DIGITAL PLATFORM

(71) Applicant: Joshua Munday, Watsonville, CA (US)

(72) Inventor: Joshua Munday, Watsonville, CA (US)

(21) Appl. No.: 19/270,273

(22) Filed: Jul. 15, 2025

Related U.S. Application Data
(60) Provisional application No. 63/672,252, filed on Jul. 17, 2024.

(51) Int. Cl. G06F 21/10; G06F 21/32; G06Q 30/0601

(52) U.S. Cl. CPC G06F 21/1014; G06F 21/32; G06Q 30/0641

(57) ABSTRACT

A system and method are disclosed for tokenizing physical assets into non-fungible tokens (NFTs) using an interactive, cloud-connected digital platform. The system includes an NFC-enabled puck affixed to a physical asset, a mobile computing device with NFC capabilities, and a digital marketplace for minting, managing, renting, and investing in NFTs. The digital platform includes modules for identity verification, asset tokenization, leasing, and investment, and is configured to interface with blockchain networks via APIs. The system supports the creation, verification, and monetization of tokenized physical assets—including vehicles, real estate, aircraft, and humanoid robots—by enabling fractional ownership, biometric authentication, and data analytics through a secure user dashboard. A suite of integrated methods facilitates asset registration, blockchain minting, rental management, and investor interaction.

### RELATED U.S. APPLICATION DATA

This application claims priority to Provisional Application No. 63/672,252, filed Jul. 17, 2024.

### FIELD OF THE INVENTION

This disclosure relates to the field of NFT blockchain technology and smart contracts, including the digital tokenization of physical property and traditionally illiquid assets, such as vehicles, estates, aircraft, and robots, along with subsequent associated physical to digital interfacing and interactions.

BACKGROUND

Physical assets such as vehicles, robots, aircraft, and real estate have traditionally been illiquid and inaccessible for investment unless owned outright. From a financial perspective, there are unfortunate real world consequences for purchasing certain physical assets. In particular, vehicle depreciation is a significant concern for car owners, as it represents the loss of value over time. One major factor contributing to depreciation is accelerated aging due to usage. The more a vehicle is driven, the more wear and tear it experiences, leading to a decline in its overall condition. This includes the degradation of mechanical components, increased mileage, and the general wear on the interior and exterior. As a result, heavily used vehicles tend to depreciate faster than those with lower usage. Overall, regardless of usage, the average vehicle tends to depreciate in value soon after being purchased.

Physical damage is another critical aspect that affects asset depreciation. Accidents, scratches, dents, and other forms of damage can significantly reduce an asset's market value. Even minor damages can lead to costly repairs, and potential buyers often view such assets as less reliable or desirable. Additionally, the cost of maintaining and repairing aging assets can become increasingly burdensome, further diminishing their value over time.

Market value fluctuations also play a role in asset depreciation. Factors such as changes in consumer preferences, the introduction of new models, and economic conditions can impact the resale value of an asset. An aging asset may struggle to compete with newer models that offer advanced features and employ newer technologies. Furthermore, as a physical object ages, it may face issues like rust, outdated technology, and reduced performance, making it less appealing to buyers and contributing to its overall depreciation.

Despite such issues related to asset depreciation, there is always an inherent value still attached to a physical asset, one that is not necessarily tied to only physical attributes. This may be related more to the unique design, type, era, or model of the asset, including the year in which it was produced, attributes that are historically unique and never change. Further, most asset owners become very attached to their property on an emotional level, some even anthropomorphizing their asset, giving it a nickname, or acting like it's a member of their family. Even if done in jest, these tendencies hint at an important underlying value to every owner's assets, one that exists independent of more traditional, physical attributes. Thus, most physical assets can be valued in a plurality of ways. All of these measures of value have not necessarily been fully tapped or explored, however, while looking through a conventional lens. The modern era of digitization can present paradigm-shifting opportunities to reassess how we represent and assess the value of physical objects, along with simple yet entertaining ways in which to access and enjoy such digitization.

### SUMMARY

This disclosure provides a comprehensive system and methods for NFT tokenization of physical assets through an interactive, cloud-based digital platform. The system includes an NFC puck affixed to a physical asset and a mobile computing device with NFC capabilities for secure data exchange. Through a mobile application, users can initiate the tokenization process by verifying asset identity, registering asset metadata, and minting an NFT using an ERC-compatible blockchain.

The system's digital marketplace supports various transactional activities, including asset leasing, fractional investment, and secure ownership transfer. It includes modules for asset tokenization, smart contract deployment, user identity verification (including biometric authentication), and a secure dashboard for both owners and investors. The backend infrastructure includes a cloud-hosted database and ERC token processing functions, with the ability to register NFTs on third-party blockchain platforms via APIs.

The methods disclosed enable owners to tokenize physical assets, manage rentals through biometric verification and usage tracking, and offer those assets to investors for fractional ownership. Investors can browse, bid on, and invest in tokenized assets, with transactions securely recorded on the blockchain and performance metrics tracked via the investor interface. Assets supported by the system include high-value physical items such as vehicles, real estate, aircraft, and humanoid robots.

### BRIEF DESCRIPTION OF THE DRAWINGS

FIG. 1 illustrates a high level diagrammatic representation of RFID/NFC tap interaction across vehicle, real estate, robot, and aircraft applications for an asset tokenization system in accordance with an embodiment of the present disclosure.

FIG. 2 illustrates a diagrammatic representation of an asset tokenization system architecture having asset registration, smart contract deployment, and NFT issuance, along with aspects of an associated digital marketplace in accordance with an embodiment of the present disclosure.

FIG. 3 illustrates a diagrammatic representation of an asset tokenization system having a user interface providing asset onboarding and trading in accordance with an embodiment of the present disclosure.

FIG. 4 illustrates a process flowchart outlining steps taken for asset tokenization using a digital platform, along with subsequent interactions with the tokenized asset using the digital platform in accordance with an embodiment of the present disclosure.

FIG. 5 illustrates a diagrammatic representation of features associated with an asset tokenization system, including means for accessing and interacting with the tokenized assets both physically and digitally via a digital platform and via an API to third party platforms in accordance with an embodiment of the present disclosure.

FIG. 6 illustrates a process flowchart outlining the rental or leasing of tokenized assets via a digital platform for an asset tokenization system in accordance with an embodiment of the present disclosure.

FIG. 7 illustrates a process flowchart outlining investment trading of tokenized assets via a digital platform for an asset tokenization system in accordance with an embodiment of the present disclosure.

FIG. 8 illustrates a vehicle operator using a mobile computing device to wirelessly establish a connection to an RFID gateway in accordance with an embodiment of the present disclosure.

FIG. 9 illustrates a vehicle operator using a mobile computing device to access a digital platform's personal dashboard by establishing a connection using tappable NFC technology in accordance with an embodiment of the present disclosure.

FIG. 10 illustrates a vehicle operator using a mobile computing device to interact with a digital platform and make a payment by using tappable NFC technology in accordance with an embodiment of the present disclosure.

### DETAILED DESCRIPTION

In the following discussion, numerous specific details are set forth to provide a thorough understanding of the disclosed subject matter. However, those skilled in the art will appreciate that the present disclosed subject matter may be practiced without such specific details. In other instances, well-known elements, processes or techniques have been briefly mentioned and not elaborated on in order not to obscure the disclosed subject matter in unnecessary detail and description. Moreover, specific details and the like may have been omitted inasmuch as such details are not deemed necessary to obtain a complete understanding of the disclosed subject matter, and are considered to be within the understanding of persons having ordinary skill in the relevant art.

The present disclosure relates to the field of blockchain asset management, specifically to a system for tokenizing physical property, or assets, such as vehicles, humanoid robots, aircraft, and real estate using blockchain technology. This system integrates RFID/NFC (Radio Frequency Identification and Near Field Communication, respectively) tap-based verification for asset authentication and ownership tracking, enabling fractional investment, trading, and secure proof of ownership. A digital platform allows users to tokenize their physical assets, including, but not limited to, vehicles (NFT Cars), humanoid robots (NFT Robot), aircraft (NFT Air), and real estate (NFT Estates) into digital tokens recorded on a cryptocurrency blockchain, such as Ethereum. These tokens represent verifiable shares of ownership and enable users to buy, sell, hold, or trade their interests securely.

A digital platform can include a user portal for account creation, such a portal having a user dashboard and a means for carrying out KYC and AML (“Know Your Customer” and Anti-Money Laundering, respectively) procedures. An admin panel may be provided for verification of documentation, such as VIN/title, robot ID tag, aircraft registration data, property deed, etc. An exemplary embodiment may support the Ethereum Network as a cryptocurrency blockchain, along with having MetaMask integration for digital wallet connectivity. Such an embodiment may further support smart contracts for token creation and distribution. Users may utilize a verification system based on RFID/NFC for physical asset registration and tap-based interactions. Ethereum smart contracts and RFID/NFC tap verification (at the location of physical asset) can provide secure asset identification and investor access. Such an embodiment can enables fractional ownership and decentralized asset trading via digital wallets.

The present invention includes an interactive digital platform associated with a unique chain (e.g. blockchain) technology and including a digital marketplace, such a digital platform further having tokenization means for creating NFTs (Non-Fungible Tokens) from real world property, especially a user's personal assets or property such as vehicles, estates, aircraft, and robots, such NFT assets being interactively accessible and manageable on a digital marketplace. In one example, tokenizing vehicles using the present system allows for users to turn their depreciated cars into an appreciated asset over time. This helps to address the unfortunate fact that most vehicles immediately start depreciating once they leave a dealership lot. Any user who purchases a car for any practical means can thus benefit from the present system and methods. A digital platform allows for the merging of a physical asset with a digital asset that is accessible on the digital marketplace. A user must simply connect their asset to a digital marketplace using a digital platform's tokenization means, and the asset becomes merged digitally on the unique chain technology.

Once an asset is connected, the owner of the physical asset will have the option to purchase RFID/NFC gateways that are installable within or on the asset, in order to better access a dashboard portal from within or near the asset, or when the user is away from it. Portable means of access include a key chain to tap into the user's NFT asset and view its status on the corresponding chain technology. Tappable NFC (Near Field Communication) technology allows a user to easily tap their mobile computing device, or smartphone, to peripheral items such as a sticker or puck installed within or on the physical asset, the peripheral items taking the user directly to a personal dashboard, where the user can monitor and manage their NFT asset. The more the asset owner engages with other or new users, the more the owner will see an appreciation of NFT key properties tied to the physical asset. If an outsourced API (Application Programming Interface) is used to access the NFT Car, but is tied to third party chain technologies, it will also allow the user to integrate with the other third party chain technologies for different assets, including cryptocurrencies that can potentially further appreciate their NFT asset (and physical property) once the asset is connected on the original unique chain technology. Potentially, this added gateway to blockchain, for example, can further grow someone's digital wallet with collectable tokens that can be sold or transferred based on the NET asset's appreciation, along with the user's engagement with a digital marketplace.

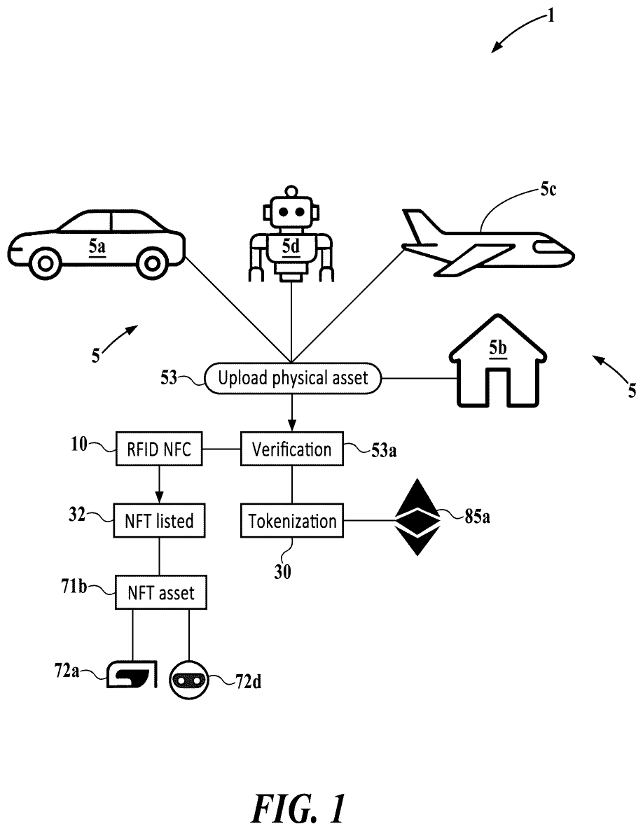

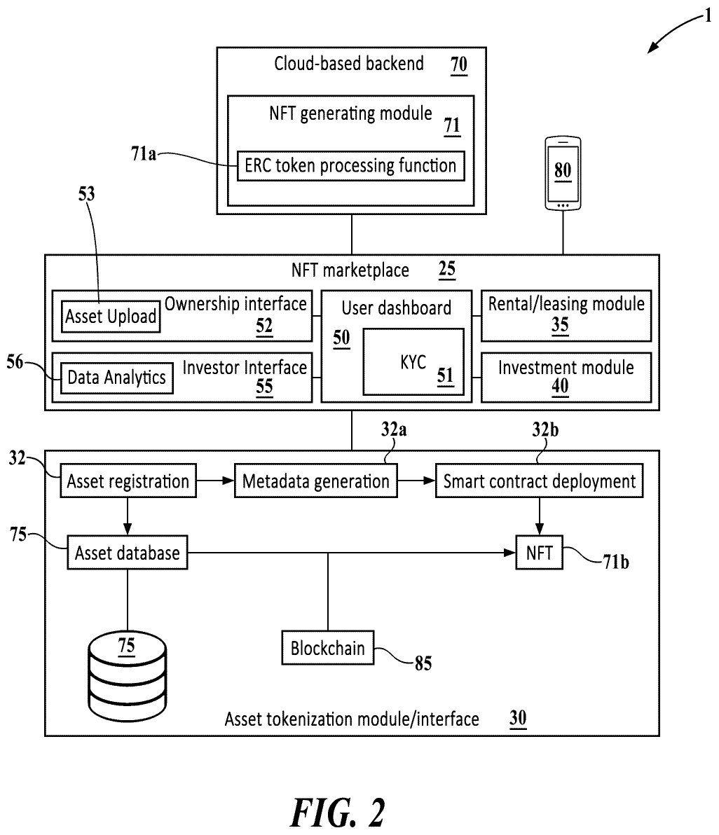

Referring to FIG. 1, a high level diagrammatic representation shows RFID/NFC tap interaction across various assets/applications for an asset tokenization system 1 providing NFT tokenization of assets and a digital platform whereby identifying information associated with real physical property can be uploaded via a user-initiated asset upload function 53. Physical property, or assets 5 can include vehicles 5a, real estate 5b, aircraft 5c, and humanoid robots 5d, along with other examples of such property. Such assets 5 can be verified via an asset verification function 53a and an associated RFID/NFC, or NFT, device 10, such as a keychain, sticker, or puck located with the asset 5. These assets 5 can be tokenized via the digital platform's asset tokenization module 30, including turning vehicles 5a, real estate 5b, aircraft 5c, and robots 5d into digital NFT tokens (or assets) 71b, such as NFT vehicles 72a and NFT robots 72d, that can be managed in a user's digital wallet. The NFT asset 71b can be associated with a cryptocurrency blockchain token such as ether 85a. The NFT asset 71b can be listed on a digital marketplace (see NFT marketplace 25 of FIG. 2) via an asset registration and minting function 32. The user may sign up on the NFT digital marketplace 25, where an affiliate key is generated to track NFT assets 71b, device or VR sales, and to receive cash payouts. The user may purchase the RFID device 10, which includes RFID tags on keychains or sticker pucks carried by the user or installed within or on the physical asset 5 in order to access an NFT asset portal or dashboard (see user dashboard 50 of FIG. 2). A user programs their NFT device 10 with a URL link (the affiliate key) and installs the sticker puck or key chain inside or on their asset 5. A user enters the digital platform's dashboard portal 50 from within or near their asset 5 via the URL link accessible via RFID (NFC) tap or QR scan.

Referring to FIG. 2, an NFT tokenization system 1 comprises an NFT marketplace 25 having a user dashboard 50, a rental/leasing module 35, an investment module 40, an ownership interface 52, and an investor interface 55, the marketplace 25 being communicatively associated with a cloud-based backend 70. The user dashboard 50 provides a user identity verification, or KYC, module 51. The ownership interface 52 comprises a user-initiated asset upload function 53 for receiving identifying information about physical assets 5. The investor interface 55 comprises a data analytics module 56 which tracks, records, and provides rental activity data, usage pattern data, and mileage data associated with the owner's uploaded/tokenized assets 71b. The backend 70 utilizes an NFT generating module 71, this module having an ERC (Ethereum Request for Comment) token processing function 71a. The NFT marketplace 25 and cloud-based backend 70 operate in tandem with an asset tokenization module 30, this module comprising an asset registration/minting function 32, a metadata registration function 32a, and a smart contract deployment function 32b which deploys NFT tokens 71b to a secure cryptocurrency blockchain 85. Once asset registration 32 has been completed, assets can be stored in one or more databases 75 accessible via the cloud-based backend 70. In an exemplary embodiment, physical assets 5 can be tokenized 30 using smart contracts supported by the Ethereum blockchain 85. Other embodiments may employ alternative crypto blockchains such as Binance Smart Chain, Solana, Cardano, Polkadot, Avalanche, Tezos, Algorand, NEAR protocol, and others.

The rental/leasing module 35 provides a forum on the NFT marketplace where asset owners can post their physical property for rental or leasing by other users. Rental activity can be recorded and aggregated as data to be viewed by the owner and potential renters, such aggregate data being storable and accessible via the RFID/NFC device 10 that locationally and identifiably corresponds to the rentable asset 5. In a preferred embodiment, NFC scanning and marketplace access are accomplished using a mobile computing device, or smartphone 80. The investment module 40 provides an interface or dashboard for the buying, selling, trading, and holding of fractional shares of tokenized NFT assets 71b securely on the NFT marketplace 25.

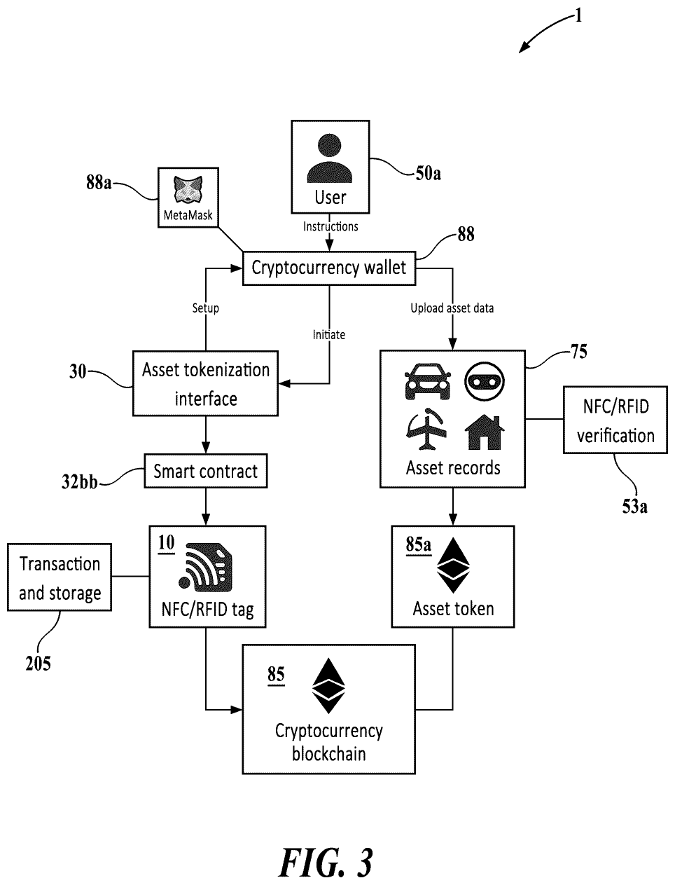

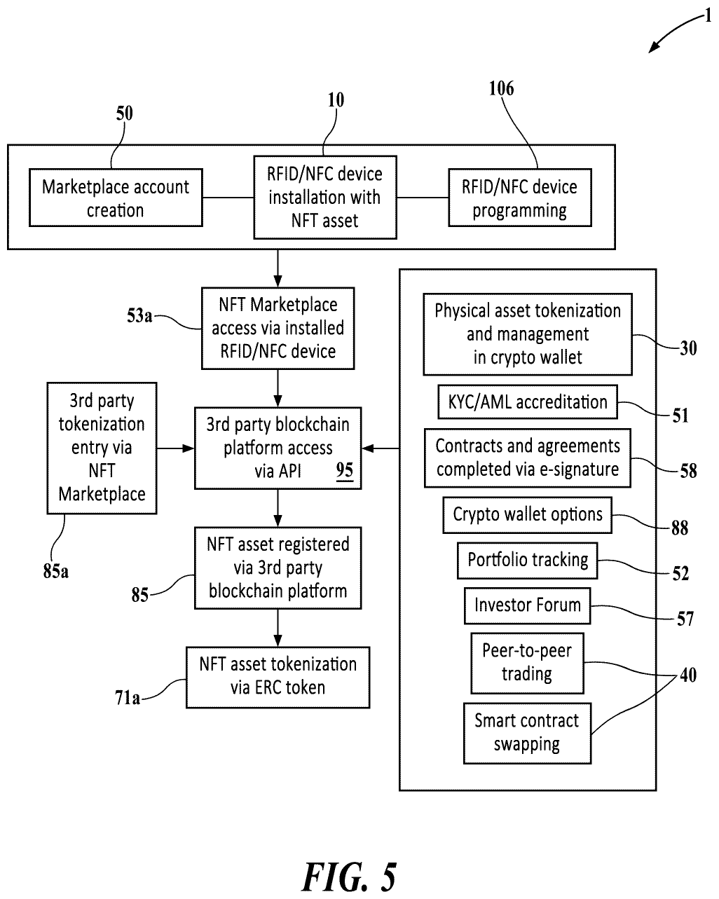

Referring to FIG. 3, and regarding the NFT tokenization system 1, a user 50a on the NFT marketplace 25 initially requests access to tokenize physical property 5, and receives instructions for installing a cryptocurrency wallet 88, such as MetaMask 88a, and for linking their ETH 85a (ether token on the Ethereum blockchain) wallet, in a preferred embodiment. KYC/AML information (see user identity verification module 51 of FIG. 5) is verified through the secure user dashboard 50. The user 50a initiates tokenization by uploading data associated with their physical asset 5 via the asset tokenization interface 30. This activity can also be followed by setup of the wallet 88. The uploaded asset data is further retained in a database 75 holding asset records, verification of such data being authenticated via an asset verification function 53a that utilizes the RFID tag 10 that is issued and installed on the tokenizable asset 5, corresponding to it. The RFID tag 10 facilitates transactional/storage activity 205 that can occur once the tag 10 is scanned with a mobile computing device and/or NFC reader. A smart contract 32bb mints the NFT 71b and deploys it to blockchain 88, the smart contract being produced via the smart contract deployment function 32b employed by the digital platform and NFT marketplace 25. An asset ownership interface associated with the user dashboard 50 allows buying, selling, trading, and holding of fractional shares of NFT assets 71b that have been registered and minted on the NFT marketplace 25. Metadata of the NFT asset 71b that is produced by the metadata registration function 32a is linked on-chain via IPFS (InterPlanetary File System) or equivalent storage protocol.

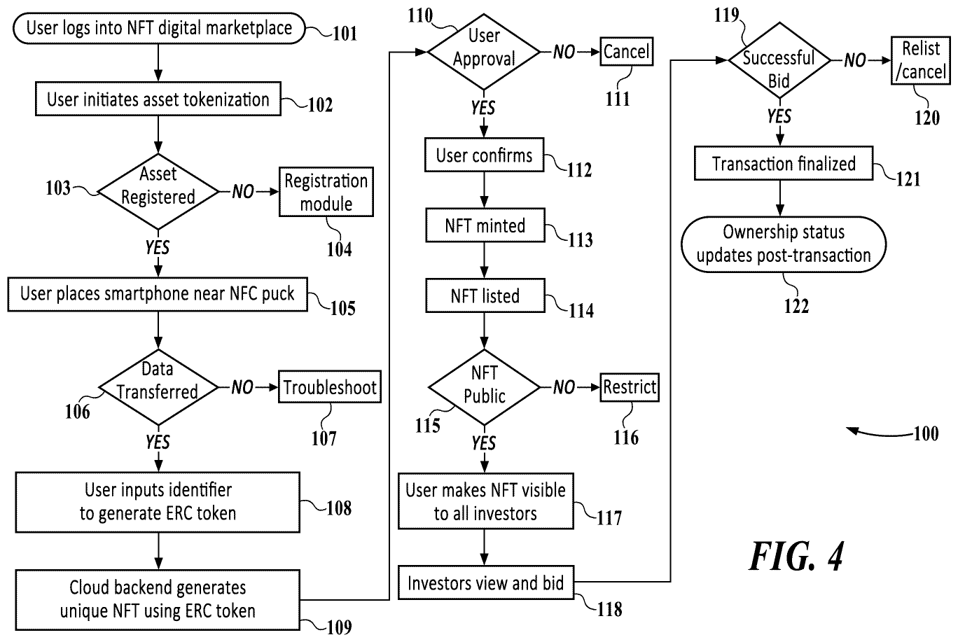

Referring to FIG. 4, a process flowchart outlines a method 100 for asset tokenization using the digital platform. An owner/user 50a first logs into the NFT marketplace 25, as indicated by step 101, accessing their user dashboard 50. The owner then initiates vehicle tokenization, as step 102 indicates. Step 103 indicates a decision to be made about whether the physical asset 5 is already registered. If it is not already registered, the owner must return to the registration module 32, as indicated by step 104. If, however, the asset 5 is registered, the owner then places their smartphone 80 near the corresponding RFID device or puck 10, as step 105 shows. It must then be determined whether or not the NFC puck 10 successfully transferred data, as step 106 indicates. If data was not transferred, the owner 50a must troubleshoot the connection, as step 107 shows. If the NFC puck 10 indeed transfers asset data, the owner inputs an identifier (such as a Vehicle Identification Number [VIN] to register a vehicle 5a, or property data for real estate, such as address or unique ID) in order to generate an ERC token, as indicated by step 108. The cloud backend 70 generates a unique NFT token 71b using ERC token technology (and ERC token processing function 71a) after the asset 5 is tokenized, as step 109 shows. ERC tokens, based on the Ethereum blockchain, are a type of digital token that adheres to specific standards (such as ERC-20 or ERC-721), enabling smart contracts and unique asset representation. This ensures seamless interoperability and secure transactions within a blockchain ecosystem. It must then be determined whether the owner approves the tokenization, as step 110 indicates. If the owner does not approve this activity, they can cancel the process, as step 111 shows. Conversely, if the user does indeed approve the tokenization, they must review and confirm the parameters of the tokenization activity, as step 112 shows. The NFT asset 71b is thus minted on the blockchain 85, as step 113 indicates. The NFT asset 71b thus appears on the NFT marketplace 25, as indicated by step 114. It must then be determined, whether the NFT 71b is set for public listing, or published, as step 115 shows. If it's not publicly listed, the owner can restrict its visibility, as step 116 indicates. If it is publicly listed, the owner can make the NFT asset 71b visible to all investors on the NFT marketplace 25, as indicated by step 117. At this point, marketplace investors can view and bid on the NFT 71b, as step 118 shows. It must then be determined whether an investor's bid was successful, as step 119 shows. If not successful, the owner may relist or cancel, as shown by step 120. If the bid was successful, the transaction can be finalized, as step 121 shows. Finally, ownership status of the associated NFT asset 71b updates post-transaction, as step 122 indicates.

Referring to FIG. 5, a diagrammatic representation shows features associated with an asset tokenization system 1, including a means for accessing and interacting with the tokenized assets both physically and digitally via a digital platform and via an API to third party platforms. Marketplace account creation 50 entails signing up on the NFT marketplace 25 and receiving an affiliate key that is generated by the digital platform to track NFTs 71b and device or VR sales, and to receive cash payouts associated with the NFT assets. An RFID/NFC (NFT) device 10 can be purchased and carried (e.g. keychain) or installed on or inside of the associated physical asset 5 in order to access the user portal with dashboard 50 on the NFT marketplace 25. The owner of the asset 5 can then proceed with the step of NFT device programming 106 via data transfer achieved using the digital portal with asset verification function 53a. The affiliate key (preferably a URL link) is programmed into the NFT device 10 which can then be installed within or on the physical asset 5, if not carried by the owner. Having programmed and installed the NFT device 10, the owner can then login to their user dashboard 50 while in proximity of the NFT device 10, by tapping the device using the standard NFC reader on their smartphone 80, or by doing a QR code scan with the smartphone.

3rd party blockchain entry can be accomplished using the user dashboard 50 of the digital marketplace 25 to gain access to the API 95 and produce a 3rd party token 85a (Ether, in a preferred embodiment). Using the API 95, the owner's NFT asset 71b can be registered to the 3rd party blockchain platform 85, the NFT 71b being tokenized via the ERC token processing function 71a.

The present system 1 offers physical asset tokenization for turning physical property 5 into digital assets 71b that can be managed in the owner's cryptocurrency wallet 88, the digital platform's asset tokenization module 30 performing the digitization procedure. The user identity verification module 51 performs KYC/AML accreditation to ensure that marketplace users are who they claim to be, along with meeting legal requirements to prevent fraud. An e-signature function 58 is utilized to sign documents electronically, these documents including contracts and agreements. Users can choose whether to keep NFT assets 71b stored in a cryptocurrency wallet 88 offered by a provider, or to manage the assets themselves. The ownership interface 52 offers portfolio tracking, via which the asset owner can track what they own and how their investments are performing. In addition to a data analytics module 56, the investor interface 55 can further provide an investor forum 57 for connecting with other investors to share insights and knowledge. The NFT investment module 40 provides a number of functions to carry out various activities, including peer-to-peer trading for exchanging assets directly with other users without involving banks. Additionally, the investment module 40 allows for the swapping of smart contracts, such that users can execute trades securely and instantly without the need for a middleman.

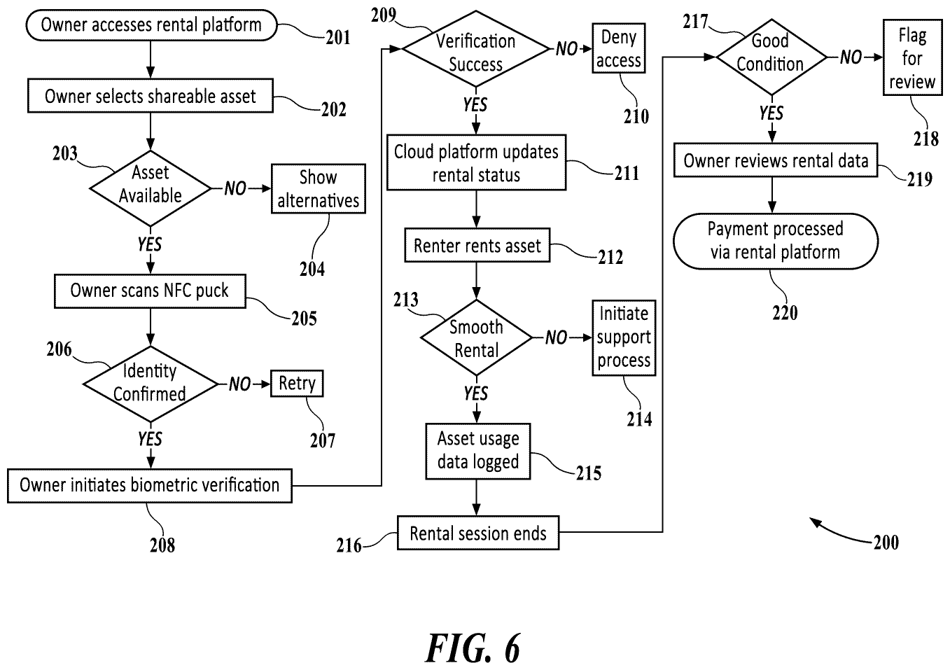

Referring to FIG. 6, a process flowchart outlines a method 200 for the rental or leasing of tokenized physical assets 5 via the digital platform for an asset tokenization system 1. An asset owner begins by accessing the rental platform 35, as step 201 shows. Next, the owner selects a shareable asset, as step 202 indicates. It must then be determined whether the asset is available for a selected timeframe, as indicated by step 203. If the asset is not available, the platform 35 can assist in showing alternative assets, as step 204 shows. If the asset is indeed available, the owner proceeds to scan the asset-associated NFT puck 10, as step 205 indicates. It must then be determined whether the asset's identity can be authenticated, as step 206 indicates. If asset verification fails, authentication must be retried, as shown by step 207. If verification is successful, the owner initiates biometric verification to authenticate their own identity, as step 208 shows. It must then be determined whether the owner's identity can be authenticated, as step 209 shows. If owner verification fails, access is denied, as shown by step 210. If verification is successful, the cloud platform updates the rental status of the associated asset, as step 211 indicates. Next, a renter can access the above-mentioned asset for rental, along with being given an option for purchasing shares of the associated NFT token 71b, as step 212 indicates. It must then be determined whether or not the rental session went smoothly, as step 213 shows. If not, the renter can initiate a support process through the rental platform 35, as step 214 indicates. If the session did go smoothly, rental usage data for the asset can be logged through the rental portal, as step 215 indicates. The rental session subsequently ends, as step 216 shows. It must then be determined whether the property was returned in good condition, as step 217 shows. If not, the session may be flagged for review, as step 218 indicates. If the property was returned in good condition, the owner can then review the rental usage data that was received by the rental platform 35, as step 219 indicates. The renter's payment can be processed via the rental platform 35, as step 220 shows.

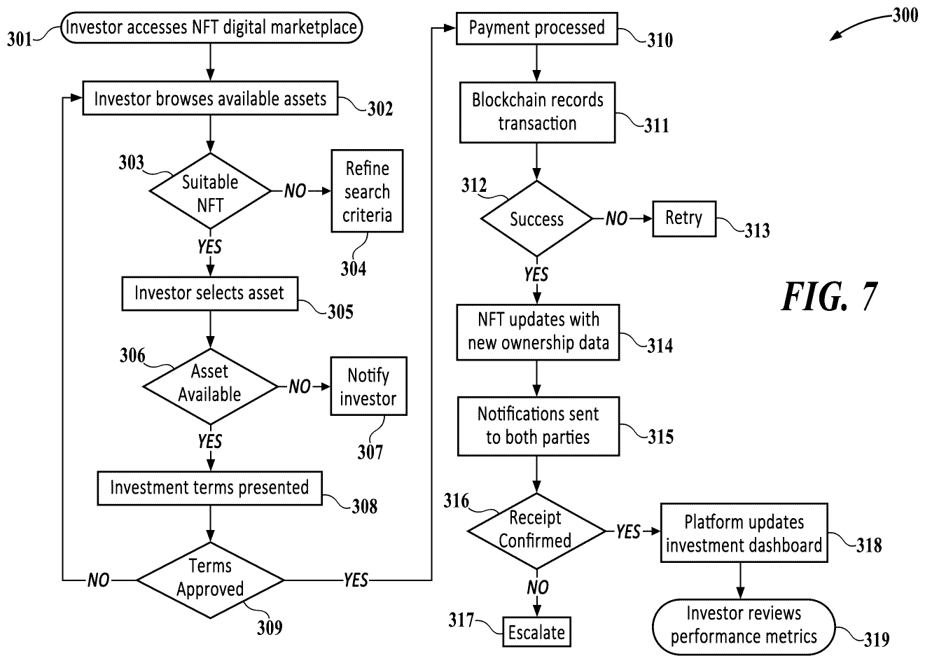

Referring to FIG. 7, a process flowchart outlines a method 300 for investment trading of tokenized NFT assets 71b via a digital platform for an asset tokenization system 1. An investor initially accesses the investor interface 55 of the NFT digital marketplace, as step 301 shows. The investor then browses for available assets, as step 302 indicates. It must then be determined whether or not a suitable NFT 71b has been located, as shown by step 303. If not, the investor can refine their search criteria, as shown by step 304. If a suitable asset has been found, the investor proceeds to select the asset for investment purposes, as indicated by step 305. It must then be determined whether or not the asset is still available for investment, as step 306 shows. If not, the investor can be notified, as step 307 shows. If the asset is still available, investment terms are then presented to the investor, as step 308 shows. It must then be determined whether or not the investment terms are acceptable. If not, the investor must return to step 302 and continue browsing available assets. If the investor approves of the terms, their payment can be processed, as indicated by step 310. Next, the associated blockchain 85 records the transaction, as step 311 shows. It must then be determined whether or not the transaction was successful, as step 312 shows. If not, the step can be retried, as step 313 shows. If the transaction was indeed successful, the NFT asset 71b updates with new ownership data, as indicated by step 314. Notifications regarding transaction information are then sent to both the owner and the investor, as step 315 shows. It must then be confirmed whether both parties received and acknowledged the notifications, as step 316 shows. If not, an escalation procedure may be initiated, as step 317 shows. If both parties acknowledge receipt of the transaction information, the digital platform updates the investment dashboard, as step 318 indicates. Finally, the investor can review performance metrics regarding their associated asset, as indicated by step 319.

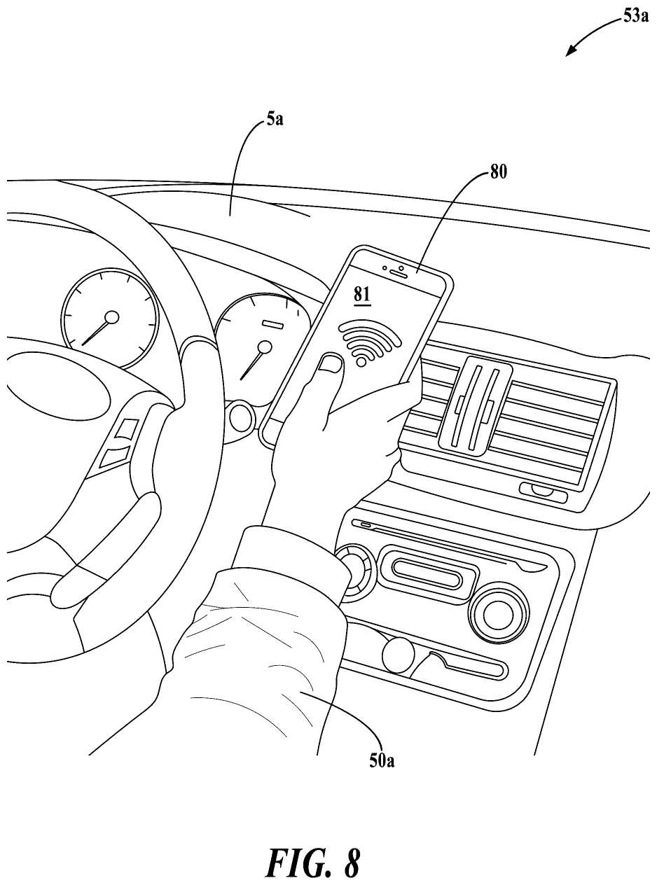

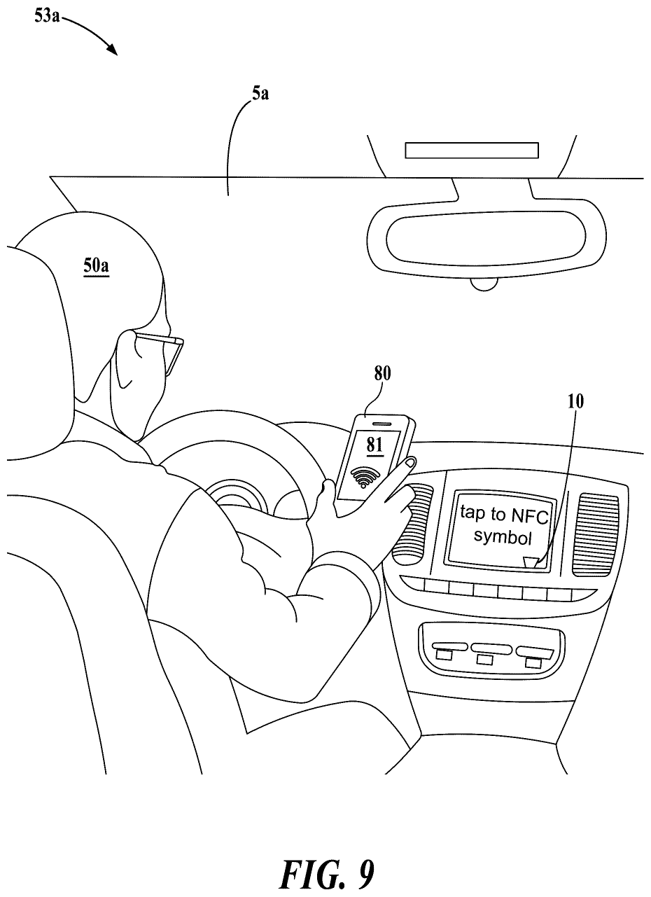

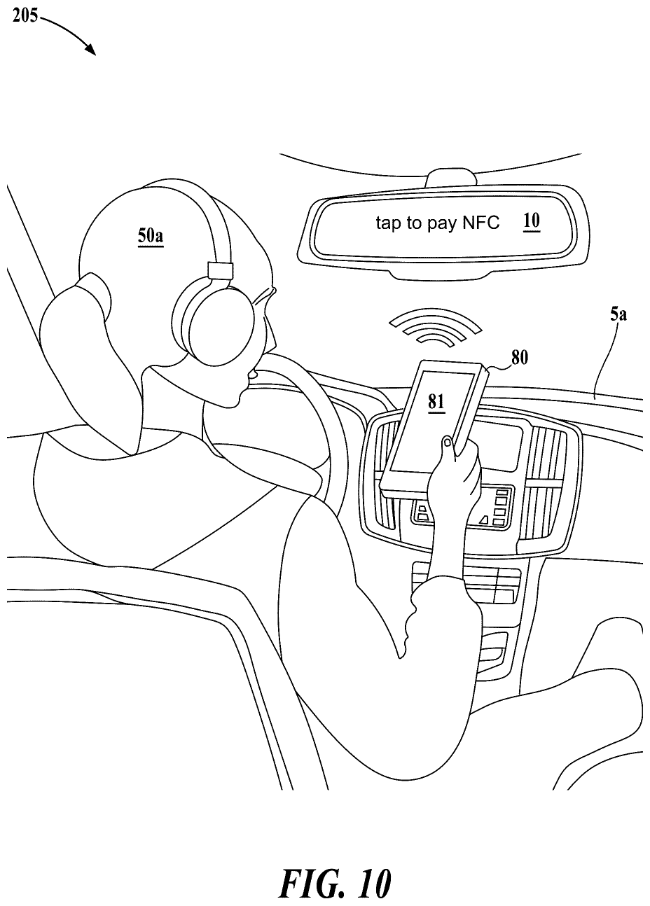

Referring to FIGS. 8-10, an operator 50a (and asset owner) of a vehicle 5a is shown using a mobile computing device 80, the device having an installed mobile application 81 along with NFC reader, to wirelessly establish a connection to an RFID gateway 10. The operator 50a can access the asset verification function 53a of the digital platform through the mobile application 81. The operator 50a can further access the digital platform's personal user dashboard 50 by establishing the connection using tappable NFC technology. The vehicle operator 50a can use their mobile computing device 80 to interact with the digital platform and NFT marketplace 25, along with performing authentication and making a payment by using the tappable NFC technology and scanning their RFID device 10 (as noted by step 205 of FIG. 6).

Regarding NFT cars 5a, the present system 1 offers tokenization of personal or commercial vehicles. An RFID/NFC chip 10 is preferably affixed near the driver side dash or internal panel. Users upload VIN, title document, and VIN plate image into the digital platform via the user dashboard 50. The vehicle is converted into ERC-based NFT shares, and investors can trade fractional shares or hold the asset.

Regarding NFT robots 5d, the present system 1 offers tokenization of humanoid robots used in domestic or commercial settings. The RFID chip 10 can be embedded inside the robot's body (e.g. in its chest panel or ID zone). Owners upload robot manufacturing serial, bill of sale, and operational registration. NFTs 71b represent ownership or fractional investment. This model enables people who don't own a robot to invest in the operational robot economy.

Regarding NFT air 5c, the present system 1 offers tokenization of aircraft such as jets, helicopters, eVTOLs, and air taxis. RFID/NFC access points can be installed near entry doors or aircraft control terminals. Aircraft owners (airlines, FBOs, charters) upload FAA registration, aircraft images, and serials. Passengers or investors buy shares in the aircraft or aircraft fleet as they travel.

Regarding NFT estates 5b, the present system 1 offers tokenization of real estate properties including single-family homes, multi-unit properties, and commercial buildings. Property deeds and titles are uploaded, along with verified geolocation and assessor's parcel number. Smart contracts bind token shares to the physical location of the property. RFID tags 10 can optionally be installed at access points (e.g. front door or control box) to validate ownership entry. Investors may purchase fractional shares in the real estate asset, participating in rental income, or asset appreciation.

The NFC device 10 (or puck) integrated into the digital platform with NFT marketplace 25 can include a number of advanced features, including an asset tokenization module (this enables the asset's physical identity to be securely paired with its digital NFT representation using a unique identifier), a wireless communication gateway (this uses NFC to seamlessly connect the asset 5 to the user's smartphone 80 and subsequently to the NFT marketplace 25), a smart verification system (this incorporates biometric authentication, e.g. fingerprint or face recognition, for accessing the digital platform, ensuring security), usage tracking and analytics (this logs data such as mileage, usage patterns, and rental activity, which investors can review for informed decisions), encrypted data transmission (the system 1 employs AES-256 encryption, a symmetric encryption standard known for its high level of security, to secure all data transmitted between the NFC puck 10, user devices, and the cloud-based platform, using 256-bit encryption keys that make it practically unbreakable and suitable for safeguarding sensitive information), dynamic access control (this provides flexible permissions for ride-share or rental activities, allowing owners to grant or revoke access in real-time; the NFC puck 10 is also highly energy efficient and does not require a battery, making it a cost-effective solution for integration with physical assets, a QR code to investor dashboard 55 being optional), and integration with IoT (Internet of Things) ecosystems (this allows connection with existing smart asset systems to enhance interoperability with third-party apps).

The KYC/AML/accreditation check 51 is generally necessary for validating the true identity of all users, along with meeting legal requirements to prevent fraud and other potential abuse of the system. E-signatures are typically utilized for signing documents electronically, such as contracts or agreements. A user may have multiple wallet options, including choosing whether to keep their assets with a wallet provider, or custodian, or managing the assets on their own, including using cold storage devices. Portfolio tracking allows a user to keep track of what they own and how their investments are performing. Investor forums 57 allow users to connect with other investors in order to share insights and knowledge related to digital assets such as NFT Cars 5a. Peer-to-peer trading allows for the direct exchange of assets with other users without involving banks. Smart contracts can be swapped, and trades executed securely and instantly without the need for a middleman.

The API 95 can offer a bridge from the present invention's digital marketplace 25 (with unique chain technology) to a third party platform (such as that having a third party blockchain). Third party tokenization entry (a third party blockchain) can occur via the unique NFT digital marketplace 25. A user registers their vehicle, real estate, aircraft, or robot (real world assets 5) with the third party platform. Thus, asset tokenization 30 using an ERC token can be completed.

In one example, using an exemplary method for asset tokenization 30, including subsequent interactions with the digital platform, a user begins by buying a car, for instance off of a lot. The car is eventually registered under the user's name. The user 50a visits the digital platform's NFT digital marketplace 25. The user 50a connects their car to the digital marketplace via the user interface 50. The user tokenizes the car using the digital platform's unique chain technology, thus making it an NFT car 71b. The user can then purchase different RFID/NFC tap technology stickers or pucks 10 to better interact with their dashboard and stats associated with their NFT car, along with viewing other NFT cars tokenized into the digital marketplace 25. The user can optionally opt-in to third party blockchains via external APIs on the digital marketplace to collect blockchain-based tokens such as Ether 85a. All functions are accessible via a mobile computing device 80, and by using the tappable RFID/NFC technology 10, or by following simple URL links to visit the user's NFT car dashboard on the digital marketplace 25. Over time, with continued user engagement, the user may notice an appreciation in the value of their NFT car. This would allow them to continue using the vehicle, transfer ownership, trade, or sell, based on the user's needs, all of these activities potentially causing an increase in the value of the car.

The NFT car platform revolutionizes how physical assets 5, particularly vehicles 5a, are tokenized into digital assets for investment purposes. The integration of near-field communication (NFC) technology streamlines this process by providing a secure and convenient method for users to interact with their vehicles and the investor marketplace 25.

In exemplary embodiments, each physical asset 5 is equipped with an NFC puck 10 that acts as a gateway between the physical asset 5 and its digital NFT counterpart 71b. This puck 10 employs cutting-edge encryption protocols, ensuring that all data transactions, from asset tokenization to rental usage, remain secure. The NFC puck 10 also integrates seamlessly with a user's smartphone, leveraging its NFC reader to facilitate instant data transfer and interaction.

Users benefit from a dynamic investor platform that supports various scenarios, such as ridesharing through services like Uber and Lyft, or car rentals via platforms like Turo. The NFC puck 10 provides a convenient gateway for these activities, enabling real-time permissions and usage tracking. This data is stored and analyzed in a cloud-based system 1, providing valuable insights to both vehicle/asset owners and investors.

The digital platform's technical foundation includes third party robust blockchain technology for secure NFT car minting and trading accessed via the NFT marketplace 25. Every transaction is recorded on the blockchain 85, ensuring transparency and immutability. Additionally, the system 1 features a modular design that supports integration with existing smart car system software, enhancing its adaptability and user experience.

The NFT estates platform transforms physical real estate 5b into digital investment opportunities by leveraging blockchain and NFC technologies. A centralized NFC puck 10 within a property enables tenants, guests, or owners to securely interact with the NFT marketplace 25. This device 10 carries a gateway between the tangible property 5b and its digital representation 71b, providing a seamless experience for tokenization and investment.

Each property 5b is tokenized into a unique NFT 71b backed by ERC token technology. Exemplary tokens adhere to Ethereum standards, ensuring interoperability and secure transactions. The NFC puck 10 uses AES-256 encryption to protect sensitive data and does not require a battery, making it both cost-effective and energy efficient.

The digital platform supports a variety of use cases, such as enabling tenants or guests to invest in the property 5b they are renting or leasing. Owners can track activity and manage access through real-time permissions. The cloud-based system logs and analyzes data, offering valuable insights for both investors and property managers.

Many variations may be made to the embodiments described herein. All variations are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

There may be many other ways to implement the disclosed embodiments. Various functions and elements described herein may be partitioned differently from those shown without departing from the scope of the disclosed embodiments. Various modifications to these implementations may be readily apparent to those skilled in the art, and generic principles defined herein may be applied to other implementations. Thus, many changes and modifications may be made to the disclosed embodiments, by one having ordinary skill in the art, without departing from the scope of the disclosed embodiments. For instance, different numbers of a given element or module may be employed, a different type or types of a given element or module may be employed, a given element or module may be added, or a given element or module may be omitted.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

1. A system for NFT tokenization of physical assets, the system comprising:
(a.) an NFC puck configured to locally interface with a physical asset;
(b.) a mobile computing device having an NFC reader;
(c.) an interactive digital platform having cloud-connectivity and configured to produce a tokenized NFT asset associated with the physical asset, the interactive digital platform comprising:
i. an NFT digital marketplace configured to support transactional activity associated with the NFT asset and corresponding with data, the NFT digital marketplace comprising:
1. an asset tokenization module having an asset identity verification function, the asset identity verification function configured to associate the NFC puck with the physical asset;
2. an asset rental and leasing module configured to support the transactional activity;
3. an NFT investment module configured to support the transactional activity;
4. a secure user dashboard having a user identity verification module, an ownership interface, and an investor interface;
ii. a cloud-based backend having at least one database for storing the NFT asset; and,
iii. a mobile application configured to associate the NFC puck with the physical asset.

2. The NFT tokenization system of claim 1, wherein the asset tokenization module further comprises a registration and minting function that includes a metadata registration function and a smart contract deployment function configured to utilize a secure cryptocurrency blockchain.

3. The NFT tokenization system of claim 2, wherein the NFT investment module includes a buying, selling, and trading interface configured to support the transactional activity associated with fractional shares of the NET asset, and wherein the NFT asset can include a vehicle, real estate, aircraft, or humanoid robot.

4. The NFT tokenization system of claim 3, wherein the user identity verification module comprises biometric authentication, the ownership interface comprises a user-initiated asset upload function providing asset verification, and the investor interface comprises a data analytics module configured to display rental activity data, usage pattern data, and mileage data associated with the NFT asset.

5. The NFT tokenization system of claim 4, wherein the cloud-based backend is configured to generate a token for the NFT asset via an ERC token processing function, and wherein the secure cryptocurrency blockchain is an encrypted storage system associated with a secure blockchain ledger, the ledger including the transactional activity data associated with the NFT asset.

6. The NFT tokenization system of claim 5, wherein an API is utilized to register the NFT asset with a 3rd party blockchain platform.

7. A method utilizing a system for NFT tokenization of assets, the method comprising:
(a.) using a mobile computing device having a mobile application and NFC technology to log into an NFT digital marketplace as a user;
(b.) initiating asset tokenization as a user for a physical asset;
(c.) if the physical asset is not registered, then navigating to a registration module;
(d.) if the physical asset is registered, then placing the mobile computing device near an RFID device proximate to the physical asset;
(e.) transferring identifying data about the asset between the mobile computing device and the RFID device via the mobile application;
(f.) if the data is not successfully transferred, then troubleshooting the connection;
(g.) if the data is successfully transferred, then inputting identifying asset data via the mobile application and NFT digital marketplace in order to generate an ERC token;
(h.) using a cloud-based backend connected to the NFT digital marketplace to generate a unique NFT asset using the ERC token, the NFT asset corresponding to the physical asset;
(i.) if the user doesn't approve of the asset tokenization, then cancelling the process;
(j.) if the user does approve of the asset tokenization, then reviewing and confirming the process;
(k.) minting the NFT asset on a cryptocurrency blockchain;
(l.) publishing the NFT asset on the NFT digital marketplace;
(m.) if the NFT asset is not set for public listing on the NFT digital marketplace, then restricting its visibility;
(n.) if the NET asset is set for public listing on the NFT digital marketplace, then making it visible to all investors in the NFT digital marketplace;
(o.) viewing and bidding on the NET asset as investors;
(p.) if an investor does not successfully bid on the NET asset, then relisting it on the NFT digital marketplace;
(q.) if an investor does successfully bid on the NET asset, then finalizing the transaction; and,
(r.) updating the ownership status of the NFT asset post-transaction on the NFT digital marketplace.

8. The method of claim 7, wherein the NFT digital marketplace is a component in a cloud-based interactive digital platform and configured to support transactional activity associated with the NFT asset and corresponding with data, the NFT digital marketplace comprising an asset rental and leasing module and an NFT investment module configured to support the transactional activity, the NFT digital marketplace further comprising a secure user dashboard having a user identity verification module, an ownership interface, and an investor interface, the cloud-based interactive digital platform further comprising a cloud-based backend having at least one database for storing the NFT asset.

9. The method of claim 8, wherein the NFT investment module includes a buying, selling, and trading interface configured to support the transactional activity associated with fractional shares of the NFT asset, and wherein the NFT asset can include a vehicle, real estate, aircraft, or humanoid robot.

10. The method of claim 9, wherein the ownership interface comprises a user-initiated asset upload function providing asset verification, and the investor interface comprises a data analytics module configured to display rental activity data, usage pattern data, and mileage data associated with the NFT asset.

11. The method of claim 10, wherein an API is utilized to register the NFT asset with a 3rd party blockchain platform.

12. A method utilizing a system for NFT tokenization of assets, the method comprising:
(a.) using a mobile computing device having a mobile application and NFC technology to log into an NFT digital marketplace and access a rental platform as a physical asset owner, the physical asset being tokenized as an NFT asset;
(b.) selecting a rentable physical asset;
(c.) if the physical asset is not available for rental, then displaying alternatives on the rental platform;
(d.) if the physical asset is available for rental, then using the mobile computing device to scan an RFID device proximate to the physical asset;
(e.) if the identity of the physical asset is not confirmed, then retrying;
(f.) if the identity of the physical asset is confirmed, then initiating biometric verification to confirm the identity of the owner;
(g.) if the biometric verification does not successfully confirm the owner's identity, then denying access to the physical asset;
(h.) if the biometric verification does successfully confirm the owner's identity, then updating a rental status of the physical asset;
(i.) renting the physical asset as a renter on the NFT digital marketplace;
(j.) if the rental does not go smoothly, then initiating a support process;
(k.) if the rental does go smoothly, then logging usage data associated with the physical asset;
(l.) ending the rental session;
(m.) if the physical asset is not in good condition, then flagging the rental for review;
(n.) if the physical asset is in good condition, then reviewing rental data associated with the rental session as the physical asset owner; and,
(o.) processing a rental payment from the renter to the owner via the rental platform.

13. The method of claim 12, wherein the NFT digital marketplace is a component in a cloud-based interactive digital platform and configured to support transactional activity associated with the NFT asset and corresponding with data, the cloud-based interactive digital platform further comprising a cloud-based backend having at least one database for storing the NFT asset.

14. The method of claim 13, wherein the NFT asset can include a vehicle, real estate, aircraft, or humanoid robot.

15. The method of claim 14, wherein an API is utilized to register the NFT asset with a 3rd party blockchain platform.

16. A method utilizing a system for NFT tokenization of assets, the method comprising:
(a.) logging into an NFT digital marketplace to access an investor platform as an investor;
(b.) browsing available NFT assets as the investor, each NET asset being associated with an owner;
(c.) if an NFT asset is not suitable, then refining search criteria as the investor;
(d.) if the NET asset is suitable, then selecting the NFT asset as the investor;
(e.) if the NFT asset is not available, then notifying the investor using the investor platform;
(f.) if the NFT asset is available, then presenting investment terms;
(g.) if the investment terms are not approved, then returning to the available NFT assets as an investor;
(h.) if the investment terms are approved, then processing the investor's payment;
(i.) recording the investment transaction on a cryptocurrency blockchain;
(j.) if the investment transaction is not successful, then retrying;
(k.) if the investment transaction is successful, then updating the NFT asset with new ownership data;
(l.) sending notifications to both the investor and the owner of the NFT asset;
(m.) if receipt of the notifications is not confirmed, then escalating;
(n.) if receipt of the notification is confirmed, then updating the investor platform; and,
(o.) reviewing performance metrics of the NFT asset as an investor.

17. The method of claim 16, wherein the NFT digital marketplace is a component in a cloud-based interactive digital platform and configured to support transactional activity associated with the NFT assets and corresponding with data, the cloud-based interactive digital platform further comprising a cloud-based backend having at least one database for storing the NFT assets.

18. The method of claim 17, wherein the investor platform corresponds to an NFT investment module that includes a buying, selling, and trading interface configured to support transactional activity associated with fractional shares of the NFT assets.

19. The method of claim 18, wherein the NFT assets can include vehicles, real estate, aircraft, or humanoid robots.

20. The method of claim 19, wherein an API is utilized to register the NFT asset with a 3rd party blockchain platform.
